(19) United States
(12) Patent Application Publication
(10) Pub. No.: US 2023/0406783 A1
(43) Pub. Date: Dec. 21, 2023

(54) COMPOSITION AND METHOD FOR TREATING AN ASPHALT PAVEMENT WITH A PENETRATING EMULSION

(71) Applicant: Heritage Research Group, LLC, Indianapolis, IN (US)

(72) Inventors: Marvin Keller Exline, Terre Haute, IN (US); Dan Swiertz, Waunakee, WI (US); Andrew Jacob Eicher, Carmel, IN (US)

(73) Assignee: Heritage Research Group, LLC, Indianapolis, IN (US)

(21) Appl. No.: 18/461,877

(22) Filed: Sep. 6, 2023

Related U.S. Application Data
(63) Continuation of application No. PCT/US2022/019304, filed on Mar. 8, 2022.
(60) Provisional application No. 63/158,512, filed on Mar. 9, 2021.

(51) Int. Cl. C04B 41/47; C04B 41/00; C04B 41/45

(52) U.S. Cl. CPC C04B 41/478; C04B 41/4535; C04B 41/009

(57) ABSTRACT

A penetrating base oil emulsion and a method of using the penetrating base oil emulsion to fill voids below the surface of an asphalt pavement. The penetrating emulation further being water resistant so as not to be washed off a pavement surface by water after being applied to the pavement. The penetrating base oil emulsion can also rejuvenate the surface of the asphalt.

### CROSS REFERENCE TO RELATED APPLICATION

This application is a continuation of International Patent Application number PCT/US2022/019304 filed Mar. 8, 2022, which claims the right of priority to U.S. Provisional Patent Application No. 63/158,512 filed on Mar. 9, 2021, the entirety of each are hereby incorporated herein by reference herein in their entirety.

### FIELD

The present disclosure relates generally to surface treatment compositions that are used to treat and/or maintain asphalt pavements. More particularly, the present disclosure is directed to a penetrating base-containing emulsion composition that penetrates asphalt pavements, settles in voids below the surface of the pavement, and rejuvenates the surface of the pavement.

### BACKGROUND

Surface treatments used for maintenance of asphalt pavements generally include coatings, penetrating or rejuvenating sealants, and aggregate-based seals.

Surface treatment coating compositions only provide a moisture and UV light barrier on the top surface of asphalt pavements. Penetrating or rejuvenating sealants are typically asphalt-based compositions that are blended with water or cutbacks that allow them to soften the surface of the pavement to penetrate the surface layer only slightly, which increases the pavement's flexibility to mitigate the impact of environmental aging.

None of the pavement maintenance options available to date provide users with viable alternatives to bituminous material-based emulsion treatments. That is, the vast majority of pavement maintenance emulsions require the use of an asphalt base dispersed in the water phase. Asphalt-based emulsions can result in the formation of a bituminous residue that reduces texture and, thus, traction at the surface of the roadway. Accordingly, there remains a need to develop non-asphalt based emulsions and/or emulsions with reduced asphalt content for the treatment and maintenance of asphalt pavement.

### BRIEF SUMMARY

According to various features, characteristics and embodiments which will become apparent as the description thereof proceeds, the present disclosure provides a penetrating base oil emulsion comprising about 25 to about 50 wt. % of a base oil content. In certain embodiments, the method comprises: forming a base oil emulsion having about 45 to 75 wt. % of a base oil, and combining the base oil emulsion with a wetting agent to produce a penetrating emulsion comprising about 25 to about 50 wt. % of the base oil.

The present disclosure further provides a method for filling voids in and/or rejuvenating an asphalt pavement. In certain embodiments the method comprises:
providing a penetrating base oil emulsion that has about 25 to 50 wt. % of an asphalt; and
   applying the penetrating emulsion onto an asphalt pavement.

In certain embodiments, the method comprises:
selecting a penetrating base oil emulsion comprising about 25 to about 50 wt. % of base oil;
   identifying an asphalt pavement, said pavement comprising a surface and voids below the surface;
applying the penetrating emulsion onto the surface of the pavement; and
allowing at least a portion of the penetrating emulsion to penetrate into the voids of the pavement.

In certain embodiments, the base oil emulsion further comprises a bituminous (e.g., asphalt) material. In certain embodiments, the base oil emulsion comprises at least one base oil and at least one asphalt material. In certain embodiments, the base oil and the at least one asphalt material together comprise about 25 to about 50 wt. % of the emulsion. In certain embodiments, the penetrating emulsion further comprises an emulsifier.

In certain embodiments, the method of preparing the penetrating emulsion comprises: forming a base oil emulsion comprising a base oil and an asphalt material, wherein the base oil and the asphalt material together comprise about 45 to about 75 wt. % of the base oil emulsion; and combining the base oil emulsion with a wetting agent to produce a penetrating emulsion, wherein the base oil and the asphalt material together comprise about 25 to about 50 wt. % of the penetrating emulsion. In certain embodiments, the penetrating emulsion further comprises an emulsifier.

The present disclosure also provides an asphalt pavement that has been treated with the penetrating base oil emulsion.

### DETAILED DESCRIPTION

The useful life of an asphalt pavement can be highly dependent upon its ability to be uniformly compacted at the time of construction of the pavement so as to create a dense matrix of asphalt coated aggregate having limited interconnected void volumes that resists the infiltration of water into the pavement structure. During the construction process, handling of the asphalt mixture can cause segregation, which can cause a non-uniform blend of the pavement aggregates, which can lead to coarse areas in the finished pavement with higher interconnected air voids. These coarse areas can comprise a high concentration of interconnected void structures that detrimentally allow water and air to permeate the asphalt pavement. The effect of such water and air intrusion can lead to more rapid oxidation of the asphalt binder and/or removal of the asphalt coating on the aggregate caused by water trapped in the pavement. Poor or inadequate compaction can also cause high air voids with high permeability to air and water. Paving in cool or cold weather can also lead to higher air void mixtures. Areas with more hand work around utilities or structures also lead to higher permeable pavements.

Construction of longitudinal and transverse joints also can produce higher air void pavements in the area around the joint. Higher air and water permeable pavements can lead to the action of water damaging the asphalt aggregate film which can lead to stripping of the asphalt film on aggregate leading to early pavement failure. Traffic loads cause mechanical action which, in addition to the higher temperatures and water vapor, are responsible for stripping of the binder from the aggregate.

Pavements in North America typically are designed for an optimum air void content of 4% in the laboratory. Most state DOT's only advise 6-7% air void in practice on roads. The result is that the road has more air and water permeability and age more quickly than designed. Once an asphalt pavement is in place, compacted and allowed to cool, the void structure is set and little post compaction occurs outside the wheel path. Agencies have required density specifications that must be met; and if the pavement is below the minimum requirements set by the Agency, pay adjustments will be made to account for loss of pavement life or, in the worst cases, the pavement may be milled and removed and a new mixture put in its place.

Traditional void filling emulsions that are capable of being diluted with water have been used as surface treatment compositions in an effort to reduce the intrusion of air and water into asphalt pavements. These emulsions, even when diluted to the point of reducing them to have a low asphalt content, typically have minimal penetration into the voids of a pavement. Accordingly, at best they only result in temporarily sealing the surface of a pavement, and can even result in loss of vehicle traction from reduced road surface texture. For example, application rates of greater than 0.1 gal/yd² are avoided, because they may leave too much asphalt on the surface, thus resulting in loss of surface texture and reduced pavement friction and its associated safety issues. Higher concentrations of surfactant in the emulsions have been tried in an effort to increase their ability to penetrate into the voids in pavements. Increasing the amount of surfactant usually results in increasing the emulsion stability while greatly slowing the emulsion's ability to set or cure, thus making it very susceptible to leaching of uncured asphalt emulsion from the pavement in the case of a rain event. This lack of water resistivity is an environmental concern releasing unbroken emulsion into ditches and streams.

Traditional asphalt-based emulsions are typically made using a colloid mill. The asphalt content of such emulsions must be high enough for the shearing action of the colloid mill to create small, uniform droplets of asphalt suspended in a water/soap solution. Typically, the asphalt content would be between 45 wt. % and 74 wt. %. For such traditional formulations, using an asphalt content below 45 wt. % at the time of shearing can create inconsistent particle size. Using an asphalt content higher than 74 wt. % creates a risk of inverting the emulsion from an oil in water to a water in oil emulsion. This results in the water/soap phase being suspended in a continuous phase of asphalt.

The present disclosure provides an alternative to traditional asphalt-based emulsions. In certain embodiments, the emulsions described herein are substantially free of asphalt content, wherein the oil phase comprises a base oil such as a vegetable oil (e.g., soybean oil). In certain embodiments, the base oil emulsion comprises a surface treatment composition that penetrates asphalt pavements and fills interconnected air voids beneath the surface of asphalt pavements to provide asphalt rejuvenation and, thus, improved resistance to water.

The present disclosure provides for a base oil-based emulsion composition referred to as a “penetrating emulsion” that has been developed to penetrate into asphalt pavements, fill voids below the surface of such pavements, and rejuvenate the pavement structure. In certain embodiments, the base oil emulsion composition of the present disclosure comprises a base oil emulsion that is made by the combined use a primary emulsifier and a surface tension reducing surfactant. In certain embodiments, the primary emulsifier is used to produce a base oil emulsion, and the surface tension reducing surfactant is added to effect penetration into an asphalt pavement.

In certain embodiments, the base oil emulsion is made by combining a water and a base oil phase to create a homogenous solution. In certain embodiments, this is done by shearing a base oil with a soap solution of water and the primary emulsifier, as well as any additional additives needed before emulsification (depending on desired application and physical characteristics). The shearing may be conducted, for example, in a colloidal mill where the components are combined at predetermined ratios to get the final desired composition of the base oil emulsion.

In certain embodiments, the penetrating emulsion of the present disclosure can be created using the post-addition of a surface tension reducing solution or a “wetting agent” (i.e., surface tension reducing solution (water and surfactant)) to the base oil emulsion. The final desired base oil content of the penetrating emulsion can be calculated to determine how much of the surface tension reducing solution needs to be added to the base oil emulsion to form the final penetrating emulsion product. In certain embodiments, this pre-calculated volume of solution and emulsion is mixed and can be pumped into an empty mixing tank, tanker truck, or emulsion distributor. In certain embodiments, the mixture is then agitated into a homogenous solution before being applied onto a desired application area.

In certain embodiments, the primary emulsifier may be selected from emulsifiers that are commonly used to form emulsions. In certain embodiments, the emulsion compositions of the present disclosure are diluted with water only; however, in alternative embodiments the emulsions can be diluted with a weak soap solution made using the same emulsifier/surfactant as used for the primary emulsifier to provide better emulsion stability. In certain embodiments, when diluting with the wetting solution (additional surfactant and water), care should to be taken to avoid over stabilization of the emulsion which can result in the emulsion not wanting to revert to a broken state in a timely fashion. Such over-stabilization could create a situation where the application of the diluted emulsion may be susceptible to leaching (poor water resistivity) for an extended period of time from, for example, further dilution by a rain event.

Primary emulsifiers will be readily appreciated by those of skill in the art. Exemplary primary emulsifiers tested in accordance with the present disclosure included tall oil-based carboxylates and alkyl amines. Non-limiting examples of tall oil-based carboxylates include PC-1542 (available from Ingevity Corporation), crude tall oil (available from Champion Paper Company) and Indulin® SA-L (available from Ingevity Corporation). Non-limiting examples of alkyl amines include, Indulin® SBT-50 (available from Ingevity Corporation), Redicote® E-7000 (an alkyl amine salt, available from AkzoNobel), and Redicote® E-47NPF (available from AkzoNobel).

Suitable surfactants will be readily appreciated by those of skill in the art. Exemplary surface tension reducing surfactants tested in accordance with the present disclosure include polymeric surfactants (ethoxylates) and mixed stream surfactants (ethoxysulfates, sulfates, sulfonates and carboxylates). Non-limiting examples of polymeric surfactants include Redicote® E-95 (available from AkzoNobel), TRITON™ X-100, TERGITOL™, TRITON™ RW-50 and ECOSURT™ EH-9 (all available from Dow Chemical), and LUTENSOL® XL 80, LUTENSOL® XP 80, and LUTENSOL® XP 90 (available from BASF). Non-limiting examples of mixed stream surfactants include BIO SOFT® LD-95 (available from Stepan Company), Dawn 2× (available from Proctor & Gamble), Redicote® E-47 NPF (available from AkzoNobel), Palmolive 11119 and Palmolive 11118 (available from Colgate-Palmolive Company).

Base oils for use in the embodiments of the present disclosure include, but are not limited to, petroleum-based oils, natural oils, and synthetic oils. Exemplary petroleum oils include, but are not limited to, Group I, Group II, and Group III oils. Synthetic oils include those that are manmade and do not exist in nature, such as polyalphaloefins (PAOs). Natural oils include, but are not limited to, animal-based oils (e.g., tallow), bio-oils such plant-based oils (e.g., triglycerides, diglycerides, and monoglycerides) and, for example, vegetable oils. Vegetable oils include, but are not limited to, soybean oil, palm oil, palm kernel oil, corn oil, castor oil, peanut oil, safflower oil, linseed oil, rapeseed oil and canola oil. Exemplary vegetable oils include those marketed and sold under the Cargill Anova® line of products, such as Anova® 1815. In certain embodiments, the vegetable oils may be modified, such as through chemical processes like epoxidation and/or oligomerization.

In certain embodiments, the penetrating emulsion can be made in a two-step process that includes a primary emulsion. In certain embodiments, the primary emulsion comprises an aqueous solution containing an emulsifier and about 45 wt. % to about 75 wt. % of a base oil. Subsequently, the primary emulsion may be diluted to any desired base oil content using the surface tension reducing surfactant diluted in water to provide the final penetrating emulsion.

Optionally, in certain embodiments the primary emulsion may further comprise an asphalt (bituminous) material. In certain embodiments the primary emulsion will comprise an aqueous solution wherein the base oil and asphalt material together comprise about 45 to about 75 wt. % of the primary emulsion. For example, in one embodiment the base oil comprises about 25 to about 55 wt. % of the primary emulsion, while the asphalt material comprises about 20 to about 50 wt. % of the primary emulsion. The final base oil/asphalt content of the penetrating emulsion (after dilution with the wetting agent solution) may range from about 25 to about 50 wt. % of the penetrating emulsion, such as about 30 to about 45 wt. % or about 38 to about 44 wt. %.

Surprisingly—and without being bound to any particular scientific theory—in certain embodiments it was discovered that the primary emulsifier functions to stabilize the base oil droplets (as well as the asphalt material if it's included in the base oil emulsion) during initial shearing to create an emulsion. Subsequent addition of the surface tension reducing surfactant creates an enhanced ability for the penetrating emulsion to penetrate asphalt pavements. With regard to such embodiments, it was further discovered that the surface tension reduction not only aids the penetrating capacity, but also enhances the early water resistance of the emulsion.

Thus, in certain embodiments, Applicant has surprisingly and unexpectedly discovered that addition of the surface tension reducing surfactant into the primary emulsifier soap at the time of initial emulsification using e.g. a colloid mill does not create the same properties as a process that first creates an emulsion with primary emulsifier with subsequent dilution using the surface tension reducing surfactant. Reduction of surface tension caused by adding the wetting agent at the time of emulsification was found to create emulsion instability and, in some cases, to the point an emulsion could not be formed. In addition, direct addition of undiluted surface tension reducing surfactant to an emulsion was also found to be detrimental to the stability of the emulsion. In certain embodiments, to achieve the desired results, it was discovered that the surface tension reducing surfactant needs to be added to the dilution water that is used to dilute the initial base oil emulsion to create the final penetrating emulsion product.

Suitable procedures for producing penetrating emulsions described herein may include the following exemplary processes. First, create the base (primary) base oil emulsion using a primary emulsifier. The starting or base emulsion will have a base oil content of from about 45 wt. % to about 75 wt. % and a typical base oil emulsion particle sized sheared by means of a colloid mill. After formation the resulting primary emulsion should be allowed to cool and stabilize. Next, water with a surface tension reducing surfactant (the wetting agent solution) according to the present disclosure is added to the primary base oil emulsion at a temperature near the emulsion temperature to dilute the emulsion, reduce the base oil content, and form the penetrating emulsion of the present disclosure. The final base oil content of the penetrating emulsion may range from about 30 wt. % to about 50 wt. % depending upon the pavement to be treated and the desired penetrating depth. The amount of surface tension reducing surfactant is generally in the range of about 0.1 to 3 wt. % based on the mass of the total diluted penetrating emulsion system. In certain embodiments, other emulsion additives that can be added, but may not be essential to the penetrating properties of the present disclosure include rejuvenators, oil type emulsions, and others that do not adversely affect the present disclosure.

The penetrating emulsion of the present disclosure may be applied to an asphalt pavement in a single pass at a heavier application rate if deeper penetration is desired. Alternatively, the penetrating emulsion can be applied in multiple, lower rate applications to limit the depth of penetration and fill more voids in the upper pavement layer.

The depth at which voids in an asphalt pavement can be filled may be altered by adjusting the base oil content of the diluted starting emulsion and the amount of surface tension reducing surfactant in the finished emulsion. In certain embodiments, a higher base oil content together with a lower amount of surface tension reducing surfactant will produce an emulsion with a reduced ability to migrate into deeper voids in an asphalt pavement. For some applications, this will be a desirable property. Examples include pavements in which the voids are in excess of 10% of the pavement's volume, such as cold-in-place recycled asphalt pavements. In such cases, the recycled pavement may be in excess of three inches thick. In such embodiments, the amount of penetrating emulsion required to fill the voids in such pavement structures would be very high. For example, penetrating emulsion may be applied to pavement at a rate on the order of approximately 1.7 gal/yd².

By controlling the base oil content of the diluted starting base oil emulsion and the amount of surface tension reducing surfactant in the finished asphalt, it is possible in certain embodiments to limit the penetration of the penetrating emulsion to no more than the top inch of pavement, which would only require an application rate of approximately 0.6 gal/yd².

For purposes of the present disclosure, the penetrating capability can be judged by a combination of two testing protocol: surface texture as measured by the sand patch test ASTM E965; and the National Center for Asphalt Technology (NCAT) falling head field permeability test. The desired result is to create a significantly reduced falling head field permeability test result while at the same time create minimal effects on the surface texture. This combination is an indication that the penetrating emulsion has penetrated the asphalt pavement and not just remained at the surface of the pavement.

### EXAMPLES

The following non-limiting examples are provided to demonstrate features and characteristics of the present disclosure. In the Examples and throughout, percentages are given as weight percentages unless otherwise indicated or determined from context.

### Example 1

In this Example, test sections are placed three-year-old asphalt. Four types of emulsions were made using bases consisting of a bio-based oil, a petroleum-based oil, and a combination of bio-oil/asphalt, a combination of petroleum oil/asphalt and an all-asphalt base.

The test sections were evaluated for texture and permeability twelve days before application of the penetrating emulsions. The tests were repeated in the same area of each test section twenty-four days after application. The results are shown in the table below. Each formulation was initially prepared such that the primary emulsion comprised water and 60 wt. % of the base (the oil, oil/asphalt, or asphalt), with Redicote® E-7000 included as the primary emulsifier. The primary base-containing emulsion was then diluted down to reduce the base (the oil, oil/asphalt, or asphalt) down to a final concentration of 38 wt. % using a Redicote® E-95 surface tension reducer diluted in water. The final concentration of E-700 and E-95 in the resulting penetrating emulsion was 1.2 and 0.08 wt. %, respectively, while the base was present at a 38 wt. % concentration.

| | | Pre- | Post- | | | | |
|---|---|---|---|---|---|---|---|
| | Application | Treatment | treatment | Texture, | Pre- | Post- | Permeability, |
| | rate, | Texture, | texture, | % | Treatment | Treatment | % |
| Base | gal/yd2 | mm | mm | change | Permeability | Permeability | change |
| Anova | 0.035 | 0.50 | 0.50 | 0 | 136 | 117 | 14 |
| 1815 | | | | | | | |
| Naphthenic | 0.030 | 0.55 | 0.55 | 0 | 417 | 162 | 61 |
| acid ester | | | | | | | |
| 50/50 | 0.11 | 0.53 | 0.57 | 8 | 627 | 218 | 65 |
| Anova | | | | | | | |
| 1815 & | | | | | | | |
| PG64-22 | | | | | | | |
| asphalt | | | | | | | |
| PG64-22 | 0.052 | 0.55 | 0.60 | 9 | 1026 | 277 | 73 |
| asphalt | | | | | | | |

### Laboratory Test to Classify an Emulsion's Penetrating Capability

Compacted asphalt mixture pavements have a void structure that is determined by a non-all-inclusive list that includes the type and size of aggregates, the design gradation, asphalt content, mix temperatures, compaction, etc. Some traditional emulsions placed on the surface of compacted asphalt pavements tend to remain on the surface of the pavements rather than penetrate below the pavement surface. Diluting an emulsion with water to reduce the base content and emulsion viscosity may allow for minor penetration into an asphalt pavement. Placing a diluted base oil emulsion on the surface of an asphalt pavement can be comparable to placing the emulsion on a filter. The smaller the openings in a filter (comparable to the voids in a pavement), the more difficult it will be for a base oil emulsion to pass through the filter (pavement). Applicant determined that a wire/mesh sieve could be used as a filter to represent and determine an ability of an emulsion to penetrate an asphalt pavement. Emulsions are evaluated during the course of the present disclosure using a laboratory wire/mesh sieve evaluation test. Our work with emulsions has determined that a #500 mesh (30 micron) sieve is useful to differentiate good from poor penetrating emulsions.

The test to classify the penetrating capacity of the penetrating emulsions of the present disclosure involves diluting the emulsions to a test standard base content of 38 wt. % and then conditioning the emulsions to a temperature of 50° C. Next, a #500 sieve is placed on a tared receiver pan and 20 grams of emulsion is poured onto the sieve. After 5 minutes, the mass of emulsion that has passed through the sieve and into the receiver pan is determined. The percent of the emulsion that passes through the #500 sieve is calculated and used to classify the penetrating capacity of the emulsion.

The penetrating emulsion of the present disclosure can be used in conjunction with all types of asphalt pavements, including, but not limited to, new hot mix asphalt pavements, longitudinal joints, aged hot mix asphalt pavements, cold in place recycled pavements, cold central plant pavements, cold mix asphalt pavements, etc.

Although the present disclosure has been described with reference to particular means, materials and embodiments, from the foregoing description, one skilled in the art can easily ascertain the essential characteristics of the present disclosure and various changes and modifications can be made to adapt the various uses and characteristics without departing from the spirit and scope of the present disclosure as described above and set forth in the attached claims.

### EMBODIMENTS

The following provides an enumerated listing of some of the embodiments disclosed herein. It will be understood that this listing is non-limiting, and that individual features or combinations of features (e.g. 2, 3 or 4 features) as described in the Detailed Description above can be incorporated with the below-listed Embodiments to provide additional disclosed embodiments herein.
1. A method of preparing a penetrating emulsion, comprising:
providing a base oil emulsion having about 45 to about 75 wt. % of a base oil; and
combining the base oil emulsion with a wetting agent solution to produce a penetrating emulsion.
2. The method of embodiment 1, wherein the base oil comprises about 25 to about 50 wt. % of the penetrating emulsion.
3. The method of embodiment 1, wherein the base oil comprises about 30 to about 45 wt. % of the penetrating emulsion.
4. The method of embodiment 1, wherein the base oil comprises about 38 to about 44 wt. % of the penetrating emulsion.
5. The method of any of the preceding embodiments, wherein the base oil emulsion further comprises an asphalt.
6. The method of embodiment 1, wherein the base oil and asphalt together comprise about 25 to about 50 wt. % of the penetrating emulsion.
7. The method of embodiment 1, wherein the base oil and asphalt together comprise 30 to about 45 wt. % of the penetrating emulsion.
8. The method of embodiment 1, wherein the base oil and asphalt together comprise about 38 to about 44 wt. % of the penetrating emulsion.
9. The method according to any of the preceding embodiments, wherein the base oil emulsion comprises water and at least one primary emulsifier.
10. The method of embodiment 9, wherein the primary emulsifier comprises at least one of a tall oil based carboxylate or an alkyl amine.
11. The method according to any of the preceding embodiments, wherein the wetting agent solution comprises water and at least one surfactant.
12. The method according to any of the preceding embodiments, wherein the wetting agent solution comprises at least one of a polymeric surfactant or a mixed stream surfactant.
13. The method according to any of the preceding embodiments, wherein the wetting agent solution comprises at least one of an alcohol ethoxylate, an amine ethoxylate, an acetylenic diol ethoxylate, or a propoxylate.
14. The method according to any of the preceding embodiments, wherein wetting agent solution comprises at least one of an ethoxysulfate, a sulfate, a sulfonate, a diamine, a fatty acid, an ether, a hydroxythioether, a siloxane, a fluorosurfactant, a quaternary salt, a betains, or a carboxylate.
15. The method according to any of embodiments 11-14, wherein the penetrating emulsion comprises about 0.1 to about 3 wt. % of the surfactant based on the total weight of the penetrating emulsion.
16. The method according to any of embodiments 9-15, wherein the penetrating emulsion comprises about 0.1 to about 3 wt. % of the primary emulsifier based on the total weight of the emulsion.
17. The method according to any of the preceding embodiments, wherein the base oil emulsion is prepared by shearing the base oil with water and an emulsifier.
18. The method of embodiment 17, wherein the shearing comprises colloidal milling.
19. The method according to any of the preceding embodiments, wherein the combining comprises homogenizing the base oil emulsion with the wetting agent.
20. The method according to embodiment 19, wherein the homogenizing comprises shearing.
21. The method according to any of the preceding embodiments, wherein the combining is conducted in a mixing tank, tanker truck, or emulsion distributor.
22. A method comprising:
providing a penetrating emulsion comprising a base oil; and
applying the penetrating emulsion onto a surface of an asphalt pavement.
23. The method of embodiment 22, wherein the base oil comprises about 25 to about 50 wt. % of the penetrating emulsion
24. The method of embodiment 22, wherein the base oil comprises about 30 to about 45 wt. % of the penetrating asphalt emulsion.
25. The method of embodiment 22, wherein the base oil comprises about 38 to about 44 wt. % of the penetrating asphalt emulsion.
26. The method of embodiment 22, wherein the penetrating emulsion further comprises an asphalt.
27. The method of embodiment 26, wherein the base oil and asphalt together comprise about 25 to about 50 wt. % of the penetrating emulsion
28. The method of embodiment 26, wherein the base oil and asphalt together comprise about 30 to about 45 wt. % of the penetrating asphalt emulsion.
29. The method of embodiment 26, wherein the base oil and asphalt together comprise about 38 to about 44 wt. % of the penetrating asphalt emulsion.
30. The method of any one of the preceding embodiments, wherein the penetrating emulsion exhibits a penetrating capacity of at least 80 wt. % within 5 minutes when passing the emulsion through a #500 mesh sieve at 50° C.
31. The method of any one of the preceding embodiments, wherein the penetrating asphalt emulsion exhibits a penetrating capacity of at least 85 wt. %.
32. The method of any one of the preceding embodiments, wherein the penetrating asphalt emulsion exhibits a penetrating capacity of at least 90 wt. %.
33. The method of any one of the preceding embodiments, wherein the penetrating asphalt emulsion exhibits a penetrating capacity of at least 95 wt. %.
34. The method of any one of the preceding embodiments, wherein the penetrating asphalt emulsion exhibits a penetrating capacity of about 90 to about 99.9 wt. %.
35. The method of any of the preceding embodiments, wherein the base oil comprises at least one of a petroleum oil, natural oil, or synthetic oil.
36. The method of any of embodiments 1-35, wherein the base oil is a petroleum oil selected from at least one of a Group I oil, a Group II oil, or a Group III oil.
37. The method of any of embodiments 1-35, wherein the base oil is a natural oil comprising a plant-based oil.
38. The method of embodiment 37, wherein the plant-based oil comprises at least one of a triglyceride, diglyceride, or monoglyceride.
39. The method of any of embodiment 37-38, wherein the plant-based oil is selected from at least one of soybean oil, palm oil, palm kernel oil, corn oil, or canola oil.
40. The method of any of embodiments 37-38, wherein the plant-based oil comprises a vegetable oil.
41. The method of embodiments 37-38, wherein the plant-based oil comprises soybean oil.
42. The method of any of embodiments 1-35, wherein the base oil comprises a synthetic oil.
43. The method of embodiment 42, wherein the base oil comprises an epoxidized oil.
44. The method of embodiment 43, wherein the base oil comprises an epoxidized vegetable oil.
45. An emulsion derived from any of the methods set forth in the preceding embodiments.
46. An emulsion comprising:
water;
about 25 to about 50 wt. % of a base oil; and
at least one emulsifier.
47. An emulsion comprising:
water;
a base oil;
an asphalt material; and
at least one emulsifier, wherein the base oil and asphalt material together comprise about 25 to about 50 wt. % of the emulsion.
48. An asphalt pavement treated with an emulsion according to any one of claims 45-47.

1. A method of preparing a penetrating emulsion, comprising:
providing a base oil emulsion having about 45 to about 75 wt. % of a base oil; and
combining the base oil emulsion with a wetting agent solution to produce a penetrating emulsion.

2. The method of claim 1, wherein the base oil comprises about 25 to about 50 wt. % of the penetrating emulsion.

3. The method of claim 1, wherein the base oil comprises about 30 to about 45 wt. % of the penetrating emulsion.

4. The method of claim 1, wherein the base oil comprises about 38 to about 44 wt. % of the penetrating emulsion.

5. The method of claim 1, wherein the base oil emulsion further comprises an asphalt.

6. The method of claim 1, wherein the base oil and asphalt together comprise about 25 to about 50 wt. % of the penetrating emulsion.

7. The method of claim 1, wherein the base oil and asphalt together comprise 30 to about 45 wt. % of the penetrating emulsion.

8. The method of claim 1, wherein the base oil and asphalt together comprise about 38 to about 44 wt. % of the penetrating emulsion.

9. The method according to claim 1, wherein the base oil emulsion comprises water and at least one primary emulsifier.

10. The method of claim 9, wherein the primary emulsifier comprises at least one of a tall oil based carboxylate or an alkyl amine.

11. The method according to claim 1, wherein the wetting agent solution comprises water and at least one surfactant.

12. The method according to claim 1, wherein the wetting agent solution comprises at least one of a polymeric surfactant or a mixed stream surfactant.

13. The method according to claim 1, wherein the wetting agent solution comprises at least one of an alcohol ethoxylate, an amine ethoxylate, an acetylenic diol ethoxylate, or a propoxylate.

14. The method according to claim 1, wherein wetting agent solution comprises at least one of an ethoxysulfate, a sulfate, a sulfonate, a diamine, a fatty acid, an ether, a hydroxythioether, a siloxane, a fluorosurfactant, a quaternary salt, a betains, or a carboxylate.

15. The method according to claim 11, wherein the penetrating emulsion comprises about 0.1 to about 3 wt. % of the surfactant based on the total weight of the penetrating emulsion.

16. The method according to claim 9, wherein the penetrating emulsion comprises about 0.1 to about 3 wt. % of the primary emulsifier based on the total weight of the emulsion.

17. The method according to claim 1, wherein the base oil emulsion is prepared by shearing the base oil with water and an emulsifier.

18. The method of claim 17, wherein the shearing comprises colloidal milling.

19. The method according to claim 1, wherein the combining comprises homogenizing the base oil emulsion with the wetting agent.

20. The method according to claim 19, wherein the homogenizing comprises shearing.

21. The method according to claim 1, wherein the combining is conducted in a mixing tank, tanker truck, or emulsion distributor.

22. A method comprising:
providing a penetrating emulsion comprising a base oil; and
applying the penetrating emulsion onto a surface of an asphalt pavement.

23. The method of claim 22, wherein the base oil comprises about 25 to about 50 wt. % of the penetrating emulsion.

24. The method of claim 22, wherein the base oil comprises about 30 to about 45 wt. % of the penetrating emulsion.

25. The method of claim 22, wherein the base oil comprises about 38 to about 44 wt. % of the penetrating emulsion.

26. The method of claim 22, wherein the penetrating emulsion further comprises an asphalt.

27. The method of claim 26, wherein the base oil and asphalt together comprise about 25 to about 50 wt. % of the penetrating emulsion.

28. The method of claim 26, wherein the base oil and asphalt together comprise about 30 to about 45 wt. % of the penetrating emulsion.

29. The method of claim 26, wherein the base oil and asphalt together comprise about 38 to about 44 wt. % of the penetrating emulsion.

30. The method of claim 22, wherein the penetrating emulsion exhibits a penetrating capacity of at least 80 wt. % within 5 minutes when passing the emulsion through a #500 mesh sieve at 50° C.

31. The method of claim 22, wherein the penetrating asphalt emulsion exhibits a penetrating capacity of at least 85 wt. %.

32. The method of claim 22, wherein the penetrating asphalt emulsion exhibits a penetrating capacity of at least 90 wt. %.

33. The method of claim 22, wherein the penetrating asphalt emulsion exhibits a penetrating capacity of at least 95 wt. %.

34. The method of claim 22, wherein the penetrating asphalt emulsion exhibits a penetrating capacity of about 90 to about 99.9 wt. %.

35. The method of claim 22, wherein the base oil comprises at least one of a petroleum oil, natural oil, or synthetic oil.

36. The method of claim 1, wherein the base oil is a petroleum oil selected from at least one of a Group I oil, a Group II oil, or a Group III oil.

37. The method of claim 1, wherein the base oil is a natural oil comprising a plant-based oil.

38. The method of claim 37, wherein the plant-based oil comprises at least one of a triglyceride, diglyceride, or monoglyceride.

39. The method of claim 37, wherein the plant-based oil is selected from at least one of soybean oil, palm oil, palm kernel oil, corn oil, or canola oil.

40. The method of claim 37, wherein the plant-based oil comprises a vegetable oil.

41. The method of claim 37, wherein the plant-based oil comprises soybean oil.

42. The method of any of claim 1, wherein the base oil comprises a synthetic oil.

43. The method of claim 42, wherein the base oil comprises an epoxidized oil.

44. The method of claim 43, wherein the base oil comprises an epoxidized vegetable oil.

45. An emulsion derived from claim 1.

46. An emulsion comprising:
water;
about 25 to about 50 wt. % of a base oil; and
at least one emulsifier.

47. An emulsion comprising:
water;
a base oil;
an asphalt material; and
at least one emulsifier, wherein the base oil and asphalt material together comprise about 25 to about 50 wt. % of the emulsion.

48. An asphalt pavement treated with an emulsion according to claim 45.
